(19) United States
(12) Patent Application Publication
(10) Pub. No.: US 2009/0132957 A1
(43) Pub. Date: May 21, 2009

(54) System and method for selecting thumbnails in a multi-page document

(75) Inventor: Amarender Reddy Kethi Reddy, Corona, CA (US)

Correspondence Address: SHARP LABORATORIES OF AMERICA, INC.;C/O LAW OFFICE OF GERALD MALISZEWSKI, P.O. BOX 270829, SAN DIEGO, CA, 92198-2829, US

(73) Assignee: Sharp Laboratories of America Inc.

(21) Appl. No.: 11/986,361

(22) Filed: Nov. 21, 2007

(51) Int. Cl. G06F 3/048

(52) U.S. Cl. 715/786

(57) ABSTRACT

A system and method are provided for selecting thumbnail images in a multi-page document. The method displays a multi-position scroll bar and a thumbnail of a document nth (initial) page. As a user modifies the scroll bar position in the display, the nth page thumbnail display is maintained. Simultaneously with maintaining the nth page thumbnail display, page numbers are displayed that are responsive to the scroll bar positions. Following the selection of a new scroll bar position display, a kth (destination) page number is displayed, along with a (kth) thumbnail associated with the kth page. For example, the kth thumbnail is displayed in response to maintaining the scroll bar position for a predetermined time duration (e.g., 1 second), or deselecting the scroll bar. In one aspect, a document total page count is simultaneously displayed.

### BACKGROUND OF THE INVENTION

1. Field of the Invention

This invention generally relates to information display software and, more particularly, to a system and method for efficiently selecting thumbnail displays in a multi-page document.

2. Description of the Related Art

In many conventional electronic document display applications, a user sequentially navigates through thumbnail images of each page in a document. The user can move forward or backwards through the thumbnails by pressing directional arrows with a mouse. Alternatively, in other applications, a user can navigate through thumbnail images of a multi-page document by selecting a page from a displayed matrix of thumbnail images. The disadvantage of either approach is that a thumbnail associated with each page of the document appears each time a user advances through the pages of a document or selects a page from a matrix of pages. Thus, the prior art thumbnail navigation techniques tend to be slow and cumbersome, especially for documents that are, for example, one hundred or more pages long.

FIG. 6 depicts a first means for navigating through thumbnail images (prior art). The display shows a thumbnail image 10 (contract-tif), page count 12, and navigation buttons 14. The navigation buttons allow the user to move back and forth through the thumbnails. For example, if the next navigation button is pressed using the curser, image 13 (corresponding to page 13) of 100 will be substituted for the current image. Thus, the user is limited to “clicking” through a 100 page document one page at a time. This navigation technique works well for documents that are less than 30 pages long, however, for longer documents (100 pages or more) this technique is significantly limiting. It should be understood that the thumbnail is a small image that takes up a very limited portion of the overall display. That is, the figure only depicts the thumbnail portion of the display. The overall display is not shown.

FIG. 7 illustrates a second means for navigating through document thumbnail images (prior art). Thumbnail images 16 of all the pages of a document are shown simultaneously. As the user moves a curser over each thumbnail, the frame surrounding the thumbnail is “outlined” 18. If a user desires to see the outlined page, the user may select the page by clicking on the thumbnail image. This navigation technique is often used in software constructed to view images produced by digital cameras.

FIG. 8 illustrates a third means for navigating through document thumbnail images (prior art). The display shows a thumbnail image (cow), page count 12, and navigation buttons 14. The navigation buttons allow the user to move back and forth through the thumbnails.

FIG. 9 illustrates a fourth means for navigating through document thumbnail images (prior art). The display shows a thumbnail image and two individual buttons 14, and page count 12. The navigation buttons 14 permit the user to move back and forth through the thumbnails.

It would be advantageous if thumbnail images of document pages could be displayed without the necessity of showing each thumbnail, as the user scrolls through the document.

### SUMMARY OF THE INVENTION

The present invention remedies the shortcomings of the prior art thumbnail depiction methods by permitting a user to scroll through the thumbnail images of a multi-page document without showing the thumbnail image associated with each page, unless for example, the user releases the scroll bar or holds the scroll bar for more than half a second. Specifically, as the user scrolls through the pages of a multi-page document, only the page numbers of the document are revealed in the user interface (UI), or alternatively, in a pop-up window. Once the scroll bar is released or held for more than a half second, the thumbnail image corresponding to the current page of the document appears alongside the corresponding page number.

Accordingly, a method is provided for selecting thumbnail images in a multi-page document. The method displays a multi-position scroll bar and a thumbnail of a document nth (initial) page. As a user modifies the scroll bar position in the display, the nth page thumbnail display is maintained. Simultaneously with maintaining the nth page thumbnail display, page numbers are displayed that are responsive to the scroll bar positions. Following the selection of a new scroll bar position display, a kth page number is displayed, along with a (kth) thumbnail associated with the kth page. For example, the kth thumbnail is displayed in response to maintaining the scroll bar position for a predetermined time duration (e.g., 1 second), or deselecting the scroll bar.

In one aspect, displaying page numbers responsive to scroll bar positions includes displaying a particular page number associated with a particular scroll bar position, while simultaneously displaying a document total page count. For example, the page numbers (and total page count) may be displayed in a pop-up window.

Additional details of the above-described method and a system for selecting thumbnail images in a multi-page document are provided below.

### BRIEF DESCRIPTION OF THE DRAWINGS

FIG. 1 is a schematic block diagram depicting a system for selecting thumbnail images in a multi-page document.

FIGS. 2A through 2C are drawings depicting a viewer display associated with the thumbnail selection system of FIG. 1.

FIGS. 3A through 3C depict examples using the present invention system to navigate through a 100-page document.

FIG. 4 is a block diagram illustrating a method for using the present invention thumbnail navigator to select a thumbnail image.

FIG. 5 is a simplified flowchart illustrating a method for selecting thumbnail images in a multi-page document.

FIG. 6 depicts a first means for navigating through thumbnail images (prior art).

FIG. 7 illustrates a second means for navigating through document thumbnail images (prior art).

FIG. 8 illustrates a third means for navigating through document thumbnail images (prior art).

FIG. 9 illustrates a fourth means for navigating through document thumbnail images (prior art).

### DETAILED DESCRIPTION

Various embodiments are now described with reference to the drawings. In the following description, for purposes of explanation, numerous specific details are set forth in order to provide a thorough understanding of one or more aspects. It may be evident, however, that such embodiment(s) may be practiced without these specific details. In other instances, well-known structures and devices are shown in block diagram form in order to facilitate describing these embodiments.

As used in this application, the terms “processor”, “processing device”, “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Various embodiments will be presented in terms of systems that may include a number of components, modules, and the like. It is to be understood and appreciated that the various systems may include additional components, modules, etc. and/or may not include all of the components, modules etc. discussed in connection with the figures. A combination of these approaches may also be used.

The various illustrative logical blocks, modules, and circuits that have been described may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC. The ASIC may reside in the node, or elsewhere. In the alternative, the processor and the storage medium may reside as discrete components in the node, or elsewhere in an access network.

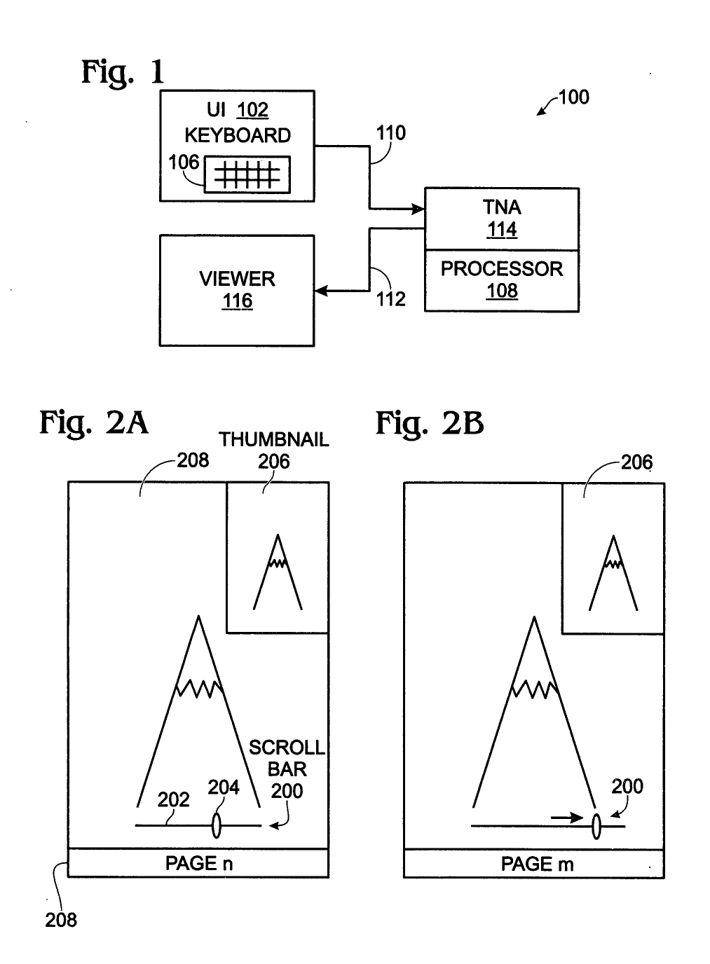

FIG. 1 is a schematic block diagram depicting a system for selecting thumbnail images in a multi-page document. The system 100 comprises a user interface (UI) 102. The UI 102 includes a means 106 for entering user commands. Some examples of such a means include a keyboard, mouse, keyboard/mouse combination, voice command interface, or touchscreen, to name a few examples. A keyboard is shown.

A processor 108 has a port connected to the UI 102 on line 110 for accepting document selections and viewer prompts. The processor 108 also has a viewer port on line 112. As would be understood by one with skill in the art, the processor interface is typically a single data/address bus. Typically, there may be dedicated hardware circuitry and software applications to manage communications between the processor 102, the UI 102, and the viewer 116. The processor 108 may be general purpose processor, such as the kind found in a personal computer, a DSP, an ASIC, FPGA, or logic-coded state machine, to name a few examples. The processor 108 also includes the hardware and software necessary to support a processor.

A thumbnail navigator application (TNA) 114 is shown embedded with the processor 108 for simplicity. As would be understood by one with skill in the art, the thumbnail navigator application 114 may be enabled as microprocessor instructions stored in memory (not shown), which are called and acted upon by the processor 108. As a result of this enablement, the TNA 114 supplies display information via the viewer port on line 112, responsive to the viewer prompts on line 110. A viewer 116 is connected to the processor 108 via line 110 for displaying a multi-position scroll bar, pages from an electronic document, and thumbnail images from the document. The viewer 116 may be a cathode ray tube (CRT), liquid crystal display (LCD), or light emitting diode (LED) array, to name a few examples. Any type of electronic display visible to a user would be sufficient to enable the invention.

An electronic document is a document that can be stored in an electronic format, such as in a hard disk memory, RAM, ROM, or other storage medium. An electronic document can be manipulated and edited. Typically, an electronic document is formatted for manipulation by a particular software application, or group of applications. An electronic document can also be communicated via an electronic communication medium. An electronic document may be divided into logical units, which can be referred to as a page. For example, a page may be described as the logical unit that can be seen (full scale) in a viewer display. An electronic page may, or may not correspond to hardcopy medium page that results from printing the electronic document. Generally, electronic documents can be divided into the categories of text and image documents. Text documents are formatted in a variation of ASCII code, while image documents are formatted as raster images. Many applications/formats incorporate both text and images. A thumbnail image, or thumbnail, is miniature representation of an electronic document page, as seen in a viewer display. A thumbnail may be superimposed over a full screen image of a page, or the “full” screen image may be “shrunk” and the thumbnail viewed in an adjacent margin. Thus, the thumbnail navigator application 114 may supply text page thumbnails, image page thumbnails, or a combination text and image thumbnails (text and image in the same thumbnail). In some aspects, thumbnails may be displayed without a full screen image being displayed.

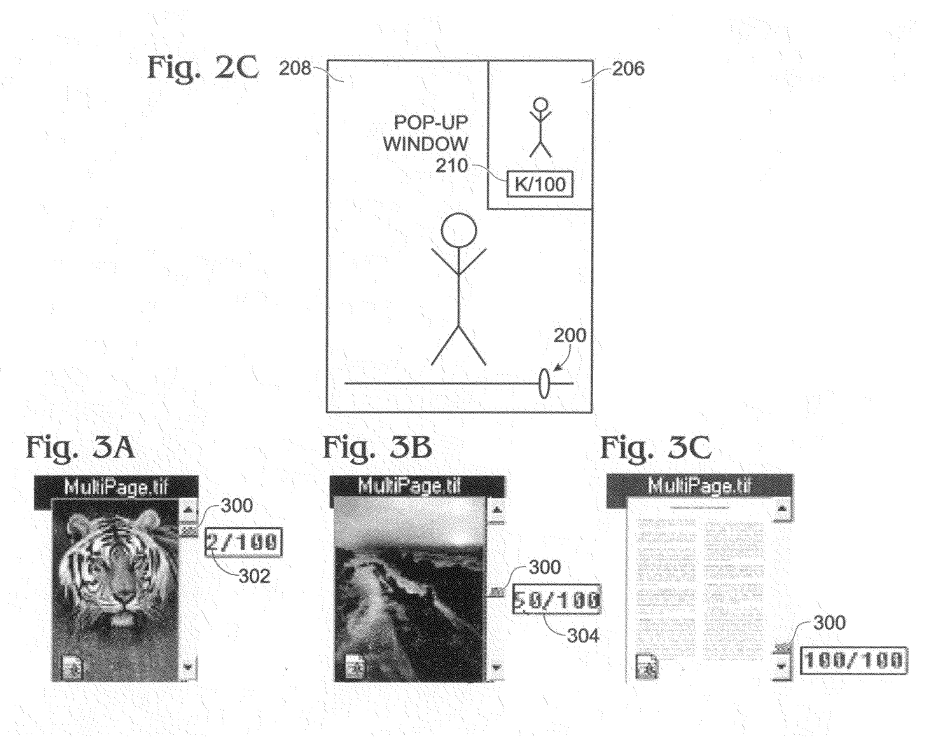

FIGS. 2A through 2C are drawings depicting a viewer display associated with the thumbnail selection system of FIG. 1. In FIG. 2A, the nth page from the selected document is shown as well as a scroll bar 200. The scroll bar is depicted as a rail 202 and position knob 204 for simplicity. However, the term “scroll bar” is intended to describe any visual means or graphical user interface (GUI) capable of indicating page position and moving through pages within a multi-page electronic document. More generally, element 200 may be referred to graphic representation of page position in a document. As shown, the scroll bar is located along the bottom edge of the display. Alternately, the thumbnail navigator application may supply display information for locating the scroll bar in a location such as to the right of the thumbnail 206, to the left of the thumbnail, above the thumbnail, or below the thumbnail. The scroll bar is not limited to any particular location.

Also shown is a thumbnail 206. In this case, the nth (initial) thumbnail is shown, corresponding to the nth page image 208. In one aspect (as shown), the viewer, prior to modifying the scroll bar position display (see FIG. 2B), simultaneously displays the nth page number with the thumbnail associated with the nth page. As shown, the nth page number is displayed in a toolbar 208 at the bottom of the page. However, the page number location is not limited to any particular position.

In FIG. 2B, the viewer (in response to UI prompts) modifies the scroll bar position, displaying page numbers responsive to scroll bar positions, while maintaining the nth page thumbnail display as the scroll bar position is modified. As shown, the scroll bar has been moved to indicate the mth (intermediate) page number. Generally, a scroll bar position is modified in response to UI prompts, which modify the scroll bar image. There are a number of visual display mechanisms that may be used to signify scroll bar position and scroll bar movement. Alternately considered, the thumbnail navigator application provides page number display information responsive to the total number of pages in the document, the location of the nth page in the document, the location of the mth page in the document, and the change in the scroll bar position.

In FIG. 2C the viewer displays a kth (destination) page number and a kth thumbnail associated with the kth page, following the selection of a new scroll bar position display. Specifically, the viewer displays the kth thumbnail in response to a particular UI operation signifying that the user has selected the new page. For example, this UI selection operation may maintain (not move) the scroll bar position for a predetermined time duration. Alternately, the scroll bar may be deselected. For example, if the scroll bar is selected with a mouse button and moved in response to mouse movement, then the scroll bar is deselected by releasing the mouse button. However, there are other means known in the art to signify deselection or the end of an operation.

In one aspect (as shown), the viewer displays a kth page 208 associated with the kth page number, following the selection of the new scroll bar position display. Alternately stated, the kth page (full scale image is shown) after the kth thumbnail is selected. Again, there are many known means to accomplish these operations. For example, the full scale image kth page may automatically be displayed after the kth thumbnail is selected.

In one aspect, as shown in FIG. 2C, the viewer displays a document total page count simultaneously with the display of the kth page number. As shown, the total page count is “100”. In the figure the current page number (k) is separated from the total count by a “/”. However, there are many other means of differentiating the current page number form the total page count which enable the system.

In another aspect of the system, the thumbnail navigator application may provide display information to enable a pop-up window. In FIG. 2C the viewer displays page numbers in the pop-up window 210. As shown, the viewer has located the pop-up window 210 adjacent the scroll bar 200 in response to display information from the thumbnail navigator application. However, the pop-up window location is not limited to any particular region of the display.

### Functional Description

This invention provides a method for navigating between pages of thumbnails of multi-page documents, which significantly simplifies the navigation between pages of thumbnails. For example, the multi-page thumbnails may be displayed with a scroll bar to the right of the thumbnail. To navigate to a particular page, user holds the scroll bar and drags down. A small pop-up window (like tool tip) shows up near the scroll bar displaying the page number based on the scrollbar position, and may also include the total number of pages. The size of the scroll thumb is proportional to the size of the document (total number of pages). The scroll bar is dragged to the desired page and the release of scroll box causes the display of the desired page thumbnail.

During the dragging of the scroll box, the thumbnail display changes only if the mouse is held down on a particular page (without movement) for a period of time, such as a half of a second or more on that page. This is helpful when the user doesn't know the exact page number. If the scroll bar is dragged fast, thumbnails will not change until the mouse button is released or the mouse position held for more than half a second. These operations make the navigation fast when user knows the exact page destination.

FIGS. 3A through 3C depict examples using the present invention system to navigate through a 100-page document. FIG. 3A represents page 2, FIG. 3B represents page 50, and FIG. 3C represents page 100. If a user desires to scroll through the 100-page document, the user places a curser on the slide bar (“bar”) 300 adjacent to the thumbnail image. As the user pulls down on the bar, the page number 302 corresponding to page position in the document is displayed alongside the thumbnail image. As long as the user is actively sliding the bar, only the page numbers changes, not the thumbnail. However, if the users holds down the slide bar for a predetermined time, such as 2 seconds, or releases the mouse, the thumbnail image and the page number corresponding to the thumbnail image appear in the display. The page number is displayed in pop-up window 304.

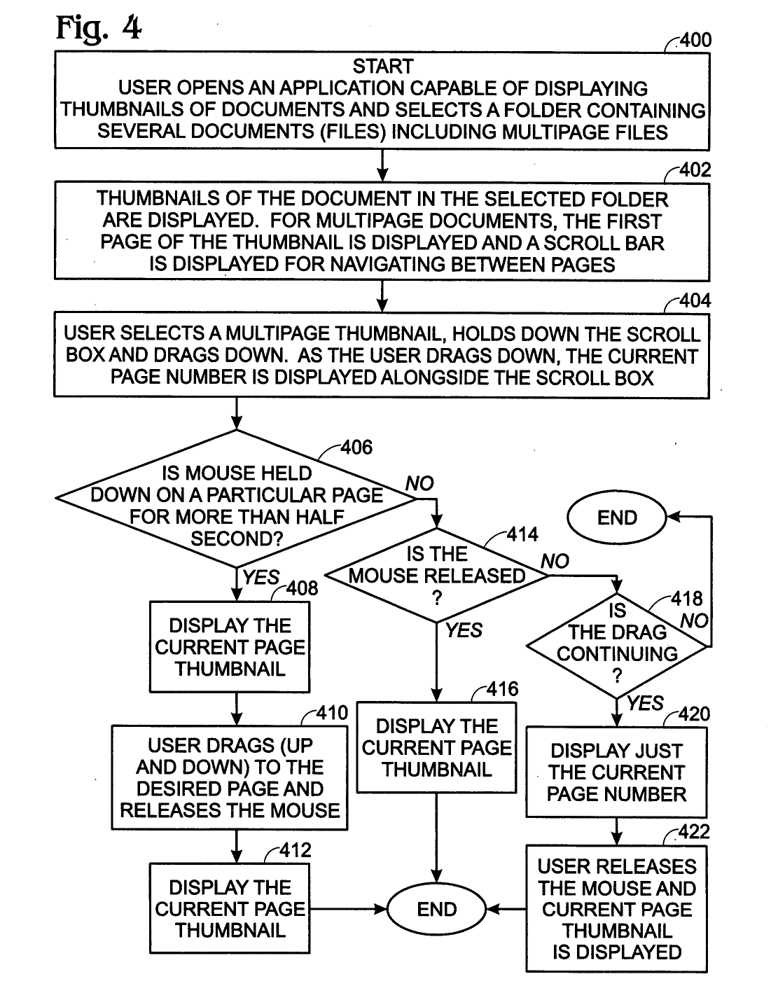

FIG. 4 is a block diagram illustrating a method for using the present invention thumbnail navigator to select a thumbnail image. In Step 400 a user opens a navigation application. The navigation application may be a separate application that works “on top of” a conventional document management application (e.g., MS® Word), or it may be embedded with a document management application. In Step 402 the scroll bar and initial thumbnail are displayed. In Step 404 manipulates the scroll bar. In Step 406 a determination is made if the mouse (scroll bar position) has been immobile for a predetermined length of time. If so, Step 408 displays the current thumbnail. In Step 410 the user selects a new thumbnail, which is displayed in Step 412.

Alternately, if a determination is made in Step 406 that the mouse (scroll bar position) has not been immobile for a predetermined length of time, the method proceeds to Step 414. If the mouse button is released, Step 416 displays the current thumbnail. If the mouse button is not released, and mouse continues to drag (Step 418), the current page number is displayed in Step 420. When the mouse is released in Step 422, the current thumbnail is displayed.

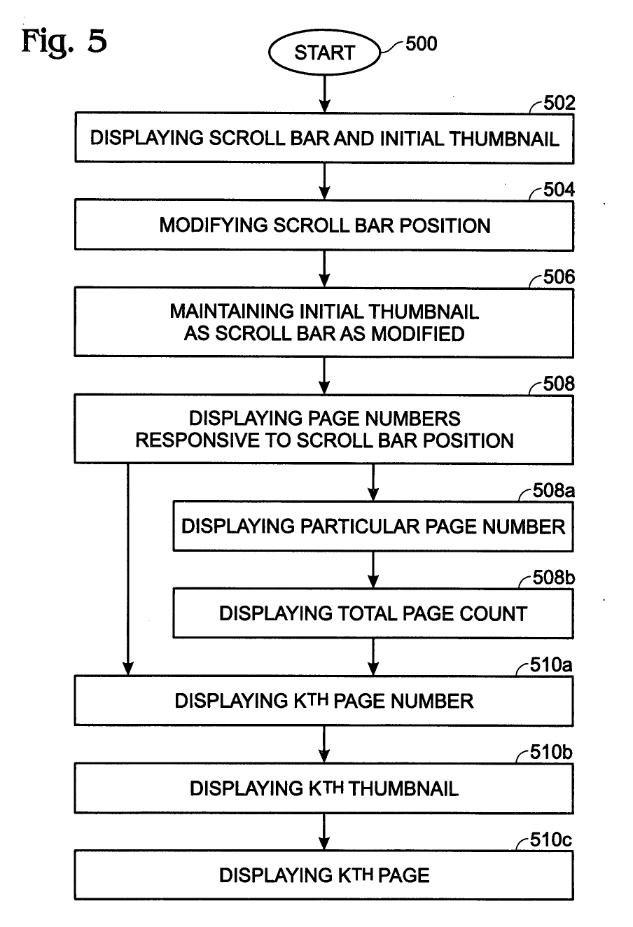

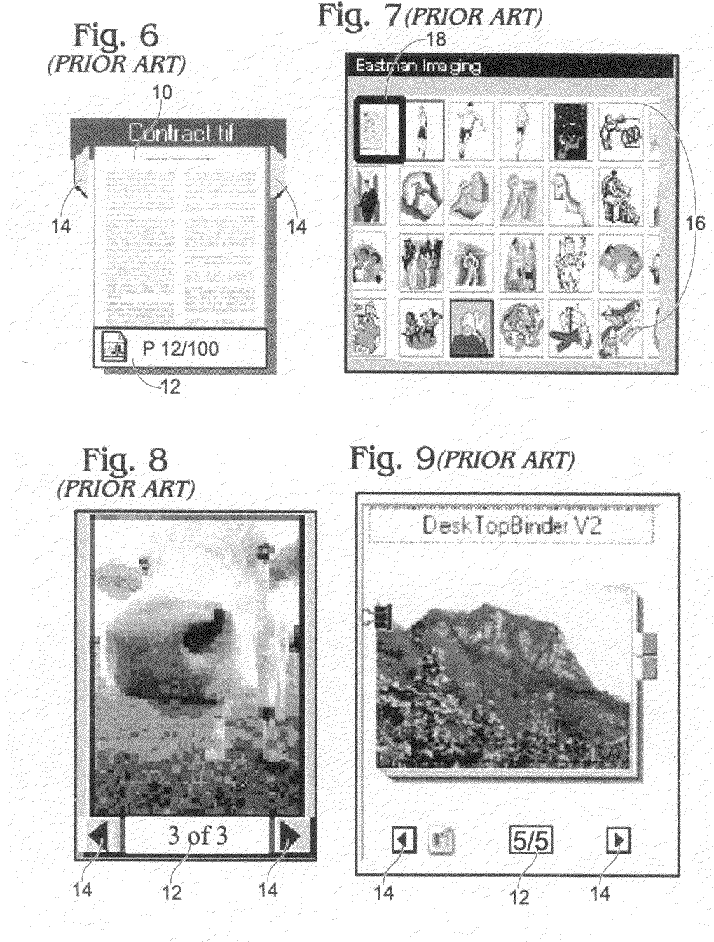

FIG. 5 is a simplified flowchart illustrating a method for selecting thumbnail images in a multi-page document. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 500.

Step 502 displays a multi-position scroll bar and a thumbnail of a document nth (initial) page. For example, the scroll bar may be located to the right of the thumbnail, to the left of the thumbnail, above the thumbnail, or below the thumbnail. Typically, the thumbnail of the document nth page (the nth thumbnail) is displayed in additional to displaying the nth page number.

Step 504 modifies the scroll bar position in the display. Step 506 maintains the nth page thumbnail display while the scroll bar position is modified. Simultaneously with maintaining the nth page thumbnail display, Step 508 displays page numbers responsive to scroll bar positions. Step 510 selects a new scroll bar position display (e.g., a position associated with the kth page). In one aspect, the new scroll bar position is selected in response to an operation such as maintaining the scroll bar position for a predetermined time duration or deselecting the scroll bar.

Step 512 displays a kth (destination) page number, and Step 514 displays a kth thumbnail associated with the kth page number in response to the selection made in Step 510. The thumbnail may be a text page thumbnail, an image page thumbnail, or a combination text and image thumbnail. In one aspect, Step 516 displays a kth (full scale) page, associated with the kth thumbnail, following the selection of the new scroll bar position display in Step 510.

In one aspect, displaying page numbers responsive to scroll bar positions in Step 508 includes substeps. Step 508a displays a particular page number associated with a particular scroll bar position. Step 508b simultaneously displays a document total page count. In one variation, the page numbers are displayed in a pop-up window. For example, the pop-up window may be adjacent the scroll bar. In another aspect, Step 508 displays page numbers responsive to the total number of pages in the document, the location of the nth page in the document, and the change in scroll bar position relative to a field of scroll bar positions.

A system and method have been presented for selecting thumbnail images in a multi-page document. Some examples of icons, displays, and particular process steps have been given as examples to illustrate the invention. However, the invention is not limited to merely these examples. Other variations and embodiments of the invention will occur to those skilled in the art.

We claim:

1. A method for selecting thumbnail images in a multi-page document, the method comprising:
displaying a multi-position scroll bar and a thumbnail of a document nth page;
modifying the scroll bar position in the display;
maintaining the nth page thumbnail display while the scroll bar position is modified; and,
simultaneously with maintaining the nth page thumbnail display, displaying page numbers responsive to scroll bar positions.

2. The method of claim 1 further comprising:
selecting a new scroll bar position display:
displaying a kth page number; and,
displaying a kth thumbnail associated with the kth page number.

3. The method of claim 2 wherein selecting the new scroll bar display includes selecting in response to an operation selected from a group consisting of maintaining the scroll bar position for a predetermined time duration and deselecting the scroll bar.

4. The method of claim 1 wherein displaying page numbers responsive to scroll bar positions includes:
displaying a particular page number associated with a particular scroll bar position; and,
simultaneously displaying a document total page count.

5. The method of claim 1 wherein displaying page numbers responsive to scroll bar positions includes displaying the page numbers in a pop-up window.

6. The method of claim 5 wherein displaying the page numbers in a pop-up window includes locating the pop-up window adjacent the scroll bar.

7. The method of claim 1 wherein displaying the multi-position scroll bar and the thumbnail image of the document nth page includes displaying a thumbnail selected from a group consisting of a text page thumbnail, an image page thumbnail, and a combination text and image thumbnail.

8. The method of claim 1 wherein displaying page numbers responsive to scroll bar positions includes displaying page numbers responsive to:
the total number of pages in the document;
the location of the nth page in the document; and,
the change in scroll bar position relative to a field of scroll bar positions.

9. The method of claim 1 wherein displaying the multi-position scroll bar and the thumbnail of the document nth page includes displaying the scroll bar, with respect to the thumbnail, in a location selected from a group consisting of to the right of the thumbnail, to the left of the thumbnail, above the thumbnail, and below the thumbnail.

10. The method of claim 1 wherein displaying the multi-position scroll bar and the thumbnail of the document nth page includes additionally displaying the nth page number.

11. The method of claim 2 further comprising:
following the selection of the new scroll bar position display, displaying a kth page, associated with the kth thumbnail.

12. A system for selecting thumbnail images in a multi-page document, the system comprising:
a user interface (UI);
a processor having a port connected to the UI for accepting document selections and viewer prompts, and a viewer port;
a thumbnail navigator application embedded with the processor to supply display information via the viewer port, responsive to the viewer prompts; and,
a viewer connected to the processor for displaying a multi-position scroll bar and a thumbnail of an nth page from the selected document, the viewer modifying the scroll bar position in response to UI prompts and displaying page numbers responsive to scroll bar positions, while maintaining the nth page thumbnail display as the scroll bar position is modified.

13. The system of claim 12 wherein the viewer displays a kth page number and a kth thumbnail associated with the kth page number, following a selection of a new scroll bar position display.

14. The system of claim 13 wherein UI selects the new scroll bar position display by performing an operation selected from a group consisting of maintaining the scroll bar position for a predetermined time duration and deselecting the scroll bar; and,
wherein the viewer displays the kth thumbnail in response to the UI operation.

15. The system of claim 13 wherein the viewer displays a document total page count simultaneously with the display of the kth page number.

16. The system of claim 12 wherein the thumbnail navigator application provides display information to enable a pop-up window; and,
wherein the viewer displays page numbers in the pop-up window.

17. The system of claim 16 wherein the viewer locates the pop-up window adjacent the scroll bar in response to display information from the thumbnail navigator application.

18. The system of claim 12 wherein the thumbnail navigator application supplies display information for a thumbnail selected from a group consisting of a text page thumbnail, an image page thumbnail, and a combination text and image thumbnail.

19. The system of claim 13 wherein the thumbnail navigator application provides page number display information responsive to the total number of pages in the document, the location of the nth page in the document, and changes in the scroll bar position.

20. The system of claim 12 wherein the thumbnail navigator application supplies display information for locating the scroll bar in a location selected from a group consisting of to the right of the thumbnail, to the left of the thumbnail, above the thumbnail, and below the thumbnail.

21. The system of claim 12 wherein the viewer, prior to modifying the scroll bar position display, simultaneously displays the nth page number with the thumbnail associated with the nth page.

22. The system of claim 13 wherein the viewer displays a kth page associated with the kth page number, following the selection of the new scroll bar position display.
